(19) United States
(12) Patent Application Publication
(10) Pub. No.: US 2010/0148857 A1
(43) Pub. Date: Jun. 17, 2010

(54) METHODS AND APPARATUS FOR LOW-VOLTAGE BIAS CURRENT AND BIAS VOLTAGE GENERATION

(76) Inventor: Ananthasayanam Chellappa, Dallas, TX (US)

Correspondence Address: TEXAS INSTRUMENTS INCORPORATED, P O BOX 655474, M/S 3999, DALLAS, TX, 75265, US

(21) Appl. No.: 12/334,214

(22) Filed: Dec. 12, 2008

(51) Int. Cl. G05F 3/02

(52) U.S. Cl. 327/538

(57) ABSTRACT

Methods and apparatus for low-voltage bias current and bias voltage generation are disclosed. An example bias signal generation circuit disclosed herein comprises a first amplifier stage, an output amplifier stage electrically coupled with the first amplifier stage, the first amplifier stage and the output amplifier stage configured to generate an output bias signal, the output amplifier stage configured to provide the output bias signal, a low impedance circuit electrically coupled with the output amplifier stage, the low impedance circuit configured to reduce an impedance of the output amplifier stage, and a current source electrically coupled with the low impedance circuit, the current source configured to drive the low impedance circuit to reduce loading of the output amplifier stage by the low impedance circuit.

### FIELD OF THE DISCLOSURE

This disclosure relates generally to bias signal generation and, more particularly, to methods and apparatus for low-voltage bias current and bias voltage generation.

### BACKGROUND

Bias signal generators are used in a variety of integrated circuits, electronic devices and electronic systems requiring stable current and/or voltage references to drive one or more constituent components and/or circuit elements. For example, bias current generators and bias voltage generators, such as bandgap voltage reference generators, are often used to bias amplifiers, power circuit/device loads, provide stable signal references to which other supply and/or input signals can be compared, etc. Conventional bias signal generators are commonly implemented using single-stage amplifier topologies because such topologies typically do not require stability compensation. However, such single-stage topologies may not be suitable for low-voltage operation. Instead, multiple-stage amplifier topologies supporting a lower supply voltage can be used to implement bias signal generators suitable for low-voltage operation. However, multiple-stage amplifier topologies typically require stability compensation, which is often achieved by adding one or more capacitors that introduce power supply rejection ratio degradation and/or significantly increase circuit size.

### SUMMARY

The methods and apparatus described herein relate generally to bias signal generation and, more particularly, to methods and apparatus for low-voltage bias current and bias voltage generation. In an example bias signal generation circuit described herein, multiple amplifier stages are configured to generate an output bias signal. The output bias signal may be an output bias current or an output bias voltage, such as a bandgap voltage reference. The example bias signal generation circuit also includes a low impedance circuit electrically coupled with an output amplifier stage that is configured to provide the output bias signal. An example low impedance circuit as described herein is configured to reduce an impedance of the output amplifier stage. Such a reduction in the impedance of the output amplifier stage can provide stability compensation for the example bias signal generation circuit without requiring the addition of a compensation capacitor. Low impedance circuit implementations described herein include, for example, one or more diodes configured to electrically couple the output amplifier stage to a circuit ground, one or more transistors arranged in a diode or similar configuration to electrically couple the output amplifier stage to the circuit ground, etc.

Additionally, at least some example implementations of the bias signal generation circuit described herein include a current source electrically coupled with the example low impedance circuit. In such an example, the current source is configured to drive the example low impedance circuit to reduce loading of the output amplifier stage by the low impedance circuit. By reducing the loading of the output amplifier stage by the low impedance circuit, any offset in the output bias signal caused by the low impedance circuit can be similarly reduced. Example current source implementations described herein include a current mirror circuit electrically coupled with the low impedance circuit and a second circuit element, such as a transistor. In such example implementations, the current mirror circuit is configured to copy, or mirror, a current provided by the second circuit element that is substantially similar to a current to be carried by the low impedance circuit. In this way, the example mirror circuit provides substantially all of the current to be carried by the example low impedance circuit, thus reducing the loading experienced by the output amplifier stage of the example bias signal generation circuit.

### BRIEF DESCRIPTION OF THE DRAWINGS

FIG. 1 is a schematic diagram of a first example prior art bias current generation circuit having a single amplifier stage not requiring stability compensation but also not suitable for low-voltage implementation.

FIG. 2 is a schematic diagram of a second example prior art bias current generation circuit suitable having multiple amplifier stages suitable for low-voltage implementation but requiring stability compensation.

FIG. 3 is a schematic diagram illustrating possible prior art compensation capacitor configurations that may be used with the second example prior art bias current generation circuit of FIG. 2.

FIG. 4 is a schematic diagram illustrating a prior art low impedance compensation scheme that does not require a compensation capacitor but that introduces a systematic offset in the generated bias current that may be used with the second example prior art bias current generation circuit of FIG. 2.

FIG. 5 is a block diagram of an example low-voltage bias current generator implemented according to the methods and apparatus described herein that has multiple amplifier stages but does not require compensation capacitors and does not introduce a systematic offset in the generated bias current.

FIG. 6 is a schematic diagram illustrating an example circuit implementation of the example low-voltage bias current generator of FIG. 5.

FIG. 7 is a schematic diagram of an example prior art bias voltage generation circuit having multiple amplifier stages suitable for low-voltage implementation but requiring stability compensation.

FIG. 8 is a block diagram of an example low-voltage bias voltage generator implemented according to the methods and apparatus described herein that has multiple amplifier stages but does not require compensation capacitors and does not introduce a systematic offset in the generated bias voltage.

FIG. 9 is a schematic diagram illustrating a first example circuit implementation of the example low-voltage bias voltage generator of FIG. 8.

FIG. 10 is a schematic diagram illustrating a second example circuit implementation of the example low-voltage bias voltage generator of FIG. 8.

FIG. 11 is a flowchart representative of an example stability compensation process that may be performed by the example low-voltage bias current and/or bias voltage generators/circuits of FIGS. 5-6, 8 and/or 9.

### DETAILED DESCRIPTION

Methods and apparatus for low-voltage bias current and bias voltage generation are described herein. The described example methods and apparatus operate to generate electrical bias signals, such as bias currents and/or bias voltages, in a low-voltage architecture. However, unlike conventional low-voltage bias signal generators based on multiple amplifier stage topologies, the example bias signal generation circuits described herein utilize a multiple amplifier stage topology that does not require one or more capacitors to provide stability compensation. As such, the example signal generation circuits described herein do not exhibit the power supply rejection ratio (PSRR) degradation and/or significantly increased circuit size resulting from the compensation capacitors used in conventional implementations.

Instead, the example signal generation circuits implemented according to the methods and apparatus described herein include a low impedance circuit electrically coupled with an output amplifier stage producing the electrical bias signal to, thereby, reduce an impedance of the output amplifier stage. Such a reduction in the impedance of the output amplifier stage can provide stability compensation for the example bias signal generation circuit without requiring the addition of a compensation capacitor and the associated PSRR degradation. Furthermore, in at least some example implementations described herein, the low impedance circuit is implemented using a diode circuit, which are often significantly smaller than the compensation capacitors used in conventional bias signal generators, thereby resulting in a smaller overall bias generation circuit size relative to conventional implementations. Such a diode circuit may be implemented using one or more diodes, one or more transistors arranged in diode configurations, any configuration providing a forward biased PN junction, etc., or any combination thereof. Additionally, to prevent a systematic offset of the generated electrical bias signal, at least some example bias signal generation circuits implemented according to the methods and apparatus described herein include a current source to drive the low impedance circuit and, thus, reduce loading of the output amplifier stage.

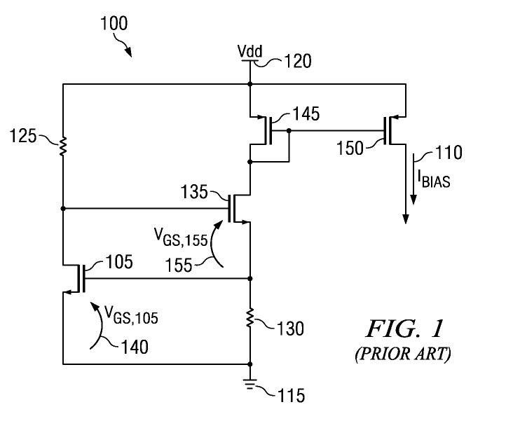

Turning to the figures, a schematic diagram of a first example prior art bias current generation circuit 100 is illustrated in FIG. 1. The example prior art bias current generation circuit 100 includes an n-type metal-oxide-semiconductor field-effect transistor (nMOSFET) 105 configured to implement a single amplifier stage for use in generating an output bias current 110. In the illustrated example, the nMOSFET 105 is arranged in a common source configuration, with the source of the nMOSFET 105 electrically coupled with a circuit ground 115 and the drain electrically coupled with a source V_{dd} voltage 120 via a resistor 125. Additionally, the gate of the example nMOSFET 105 is electrically coupled to another resistor 130 which is coupled to the circuit ground 115. Furthermore, in the illustrated example, the nMOSFET 105 is electrically coupled with another nMOSFET 135 arranged in a source follower configuration, with the drain of the nMOSFET 105 electrically coupled with the gate of the nMOSFET 135 and the gate of the nMOSFET 105 electrically coupled with the source of the nMOSFET 135.

The example nMOSFETs 105 and 135, along with the example resistor 130, implement a feedback configuration in which the example nMOSFET 135 is used as a feedback transistor to set a voltage across the resistor 130 and, thus, between the gate and source of the example nMOSFET 105. This feedback configuration causes the voltage across the example resistor 130 to be sufficient to turn on the example nMOSFET 105. The resulting gate-to-source voltage 140 of the nMOSFET 105 is labeled V_{GS,105} in FIG. 1. This gate-to-source voltage 140 across the example resistor 130 yields a current through the resistor 130 that is used to generate the output bias current 110.

The example prior art bias current generation circuit 100 also includes a pair of p-type MOSFETs (pMOSFETs) 145 and 150 configured to implement a current mirror circuit. In the illustrated example, the sources of the example pMOSFETs 145 and 150 are both electrically coupled to the source Vdd voltage 120. Additionally, the gates of both example pMOSFETs 145 and 150 are electrically coupled together, with the gate and the drain of the example pMOSFET 145 also being coupled together. Such a configuration of the example pMOSFETs 145 and 150 causes a current provided at the drain of the example pMOSFET 145 to be mirrored at the drain of the example pMOSFET 150. In other words, the current provided at the drains of the example pMOSFETs 145 and 150 will be substantially the same. Here, the current at the drain of the example pMOSFET 145 is substantially equal to the current through the resistor 130 resulting from the gate-to-source voltage 140 of the example nMOSFET 105 applied across the resistor 130. This current at the drain of the example pMOSFET 145 is mirrored to the drain of the example pMOSFET 150 and becomes the output bias current 110.

In the example prior art bias current generation circuit 100 of FIG. 1, the source follower configuration of the example nMOSFET 135 and the current mirror configuration of the example pMOSFETs 145 and 150 both have substantially unity gain. As such, the example nMOSFET 105 implements the single effective gain stage of the example prior art bias current generation circuit 100. Because the example prior art bias current generation circuit 100 has only one effective gain stage yielding one high impedance node, stability compensation is not needed as the circuit has only one dominant pole, which is the pole associated with the high impedance node. However, the example prior art bias current generation circuit 100 may not be suitable for low-voltage applications because the voltage drop from the source V_{dd} voltage 120 to the circuit ground 115 includes two gate-to-source voltage drops (the gate-to-source voltage 140 of the example nMOSFET 105 and the gate-to-source voltage 155 of the example nMOSFET 135, labeled V_{GS,155} in FIG. 1).

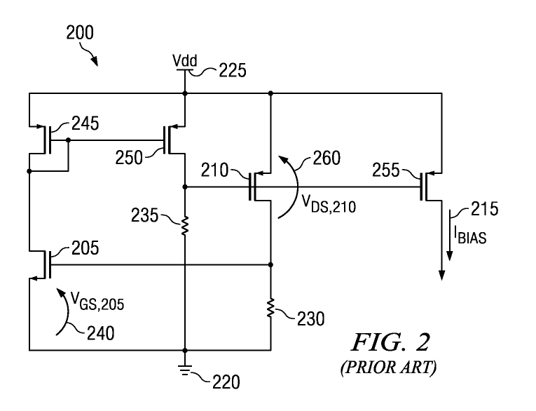

A schematic diagram of a second example prior art bias current generation circuit 200 suitable for low-voltage operation is illustrated in FIG. 2. The second example prior art bias current generation circuit 200 utilizes two amplifier stages supporting a lower supply voltage than the first example prior art bias current generation circuit 100 of FIG. 1. However, unlike the first example prior art bias current generation circuit 100, the second example prior art bias current generation circuit 200 does require stability compensation to make one of the poles associated with the high impedance nodes corresponding to the two gain stages dominant.

Turning to FIG. 2, the example prior art bias current generation circuit 200 includes an nMOSFET 205 and a pMOSFET 210 configured to implement respective first (or initial) and second (or output) amplifier stages for use in generating an output bias current 215. In the illustrated example, the nMOSFET 205 is arranged in a common source configuration, with the source of the nMOSFET 205 electrically coupled with a circuit ground 220 and the drain electrically coupled with a source V_{dd} voltage 225 via a current mirror circuit discussed in greater detail below. Additionally, the gate of the example nMOSFET 205 is electrically coupled to a resistor 230 which is coupled to the circuit ground 220. The pMOSFET 210 of the illustrated example is also arranged in a common source configuration, with the source of the pMOSFET 210 electrically coupled with the source V_{dd} voltage 225 and the drain electrically coupled with the circuit ground 220 via the resistor 230. Furthermore, the gate of the example pMOSFET 210 is electrically coupled to another resistor 235 which is coupled to the circuit ground 220. The gate of the example pMOSFET 210 is also electrically coupled with the current mirror circuit discussed in greater detail below.

Similar to the first example prior art bias current generation circuit 100 of FIG. 1, the gate-to-source voltage 240 of the nMOSFET 205, labeled V_{GS,205} in FIG. 2, yields a current through the resistor 230 that is used to generate the output bias current 215 of the second example prior art bias current generation circuit 200. However, unlike the feedback configuration of FIG. 1, the second example prior art bias current generation circuit 200 utilizes the current mirror circuit implemented by a pair of pMOSFETs 245 and 250 to drive the example nMOSFET 205 and produce the gate-to-source voltage 240. In the illustrated example, the sources of the example pMOSFETs 245 and 250 are both electrically coupled to the source Vdd voltage 225. Additionally, the gates of both example pMOSFETs 245 and 250 are electrically coupled together, with the gate and the drain of the example pMOSFET 245 also being coupled together. Such a configuration of the example pMOSFETs 245 and 250 causes a current provided at the drain of the example pMOSFET 245 to be mirrored at the drain of the example pMOSFET 250 and vice versa. In other words, the current provided at the drains of the example pMOSFETs 245 and 250 will be substantially the same. Here, the current at the drain of the example pMOSFET 250 is substantially equal to the current through the resistor 235. This current at the drain of the example pMOSFET 250 is mirrored to the drain of the example pMOSFET 245, requiring the gate-to-source voltage 240 to be biased to turn the example nMOSFET 205 on.

The gate-to-source voltage 240 across the example resistor 230 yields a current through the example resistor 230 that is substantially equal to the current at the drain of the example pMOSFET 210. The example prior art bias current generation circuit 200 of FIG. 2 further includes a pMOSFET 255 electrically coupled to the example pMOSFET 210 and configured to copy the current at the drain of the example pMOSFET 210 to produce the output bias current 215. In the illustrated example, the sources of the example pMOSFETs 210 and 255 are both electrically coupled to the source Vdd voltage 225. Additionally, the gates of both example pMOSFETs 210 and 255 are electrically coupled together to have substantially similar biasing, thus causing the current provided at the drain of the example pMOSFET 255, which is the output bias current 215, to be a substantial copy of the current provided at the drain of the example pMOSFET 210 and generated by applying the gate-to-source voltage 240 across the example resistor 230.

In the illustrated example, the voltage drop from the source V_{dd} voltage 225 to the circuit ground 220 includes only the gate-to-source voltage 240 of the nMOSFET 205 and the drain-to-source voltage 260 of the pMOSFET 210, labeled V_{DS,210} in FIG. 2. This is a smaller voltage drop than that of the first example prior art bias current generation circuit 100 of FIG. 1, thus making the second example prior art bias current generation circuit 200 more suitable for low-voltage applications. However, because the example prior art bias current generation circuit 200 has two effective gain stages corresponding to two high impedance nodes, one corresponding to the example nMOSFET 205 and the other corresponding to the example pMOSFET 210, stability compensation is needed to make one of the two poles associated with the two high impedance nodes dominant.

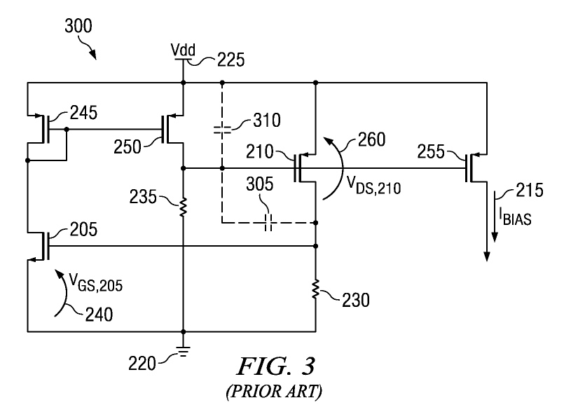

An example bias current generation circuit 300 depicting two possible prior art compensation capacitor configurations that may be used to provide stability compensation for the second example prior art bias current generation circuit 200 of FIG. 2 is illustrated in FIG. 3. The example bias current generation circuit 300 includes elements in common with the example prior art bias current generation circuit 200 of FIG. 2. As such, like elements in FIGS. 2 and 3 are labeled with the same reference numerals. The detailed descriptions of these like elements are provided above in connection with the discussion of FIG. 2 and, in the interest of brevity, are not repeated in the discussion of FIG. 3.

Turning to FIG. 3, in a first implementation of the example prior art bias current generation circuit 300, a first compensation capacitor 305 is electrically coupled between the gate and the drain of the example pMOSFET 210 implementing the second amplifier stage of the example prior art bias current generation circuit 200. In such a configuration, the first compensation capacitor 305 provides Miller compensation in the form of pole splitting. Without the first compensation capacitor 305, the example prior art bias current generation circuit 200 has two low frequency poles associated with the example resistor 235 and the example pMOSFET 210. With the first compensation capacitor 305, the two low frequency poles are split into a lower frequency pole associated with the example resistor 235 and a higher frequency pole associated with the example pMOSFET 210.

For example, a rule of thumb is to move the higher frequency pole associated with the example pMOSFET 210 to twice the unity gain bandwidth (UGB) of the example bias current generation circuit 300. Based on this rule of thumb, the first compensation capacitor 305 needs to satisfy Equation 1, given by:

gₘ₂₁₀/C_{gs,205}=2(g_{m,205}/C_{c,305}). Equation 1

In Equation 1, g_{m,205} is the transconductance associated with the example nMOSFET 205, g_{m,210} is the transconductance associated with the example pMOSFET 210, C_{gs,205} is substantially the capacitance between the gate and source of the example nMOSFET 205, and also includes other stray capacitance between these two circuit nodes, and C_{c,305} is the value of the first compensation capacitor 305. Rearranging Equation 1, the value of the first compensation capacitor 305 is given by Equation 2, which is:

C_{c,305}=2(g_{m,205}/g_{m,210})C_{gs,205}. Equation 2

Assuming the example nMOSFET 205 and the example pMOSFET 210 have similar transconductances, then C_{c,305}, the value of the first compensation capacitor 305, is similar to C_{gs,205}, the capacitance between the gate and source of the example nMOSFET 205. Thus, the first compensation capacitor 305 can be a relatively small value having a correspondingly small impact on circuit area. However, the first compensation capacitor 305 will cause degradation in the high frequency PSRR exhibited by the example bias current generation circuit 300 relative to that of the example prior art bias current generation circuit 200. The high frequency PSRR degrades because the impedance of the first compensation capacitor 305 decreases at high frequency, causing the source V_{dd} voltage 225 to be coupled onto the gate of the example nMOSFET 205. Because the node at the gate of the example nMOSFET 205 is expected to be referenced to the circuit ground 220, such coupling causes high frequency PSRR degradation.

In a second implementation of the example prior art bias current generation circuit 300, a second compensation capacitor 3 10 is electrically coupled between the gate and the source of the example pMOSFET 210 implementing the second amplifier stage of the example prior art bias current generation circuit 200. In such a configuration, the second compensation capacitor 310 provides parallel compensation to improve stability of the example bias current generation circuit 300 relative to that of the example prior art bias current generation circuit 200 without degrading PSRR. However, the second compensation capacitor 310 does not provide Miller compensation in the form of pole splitting but, instead, operates to move one of the poles lower in frequency.

For example, and as discussed above, a rule of thumb is to move the higher frequency pole to twice the UGB of the example bias current generation circuit 300. Based on this rule of thumb, the second compensation capacitor 310 needs to satisfy Equation 3, given by:

1/(R₂₃₀C_{GS,205})=2(g_{m,205}g_{m,210}R₂₃₀/C_{c,310}). Equation 3

In Equation 3, g_{m,205} is the transconductance associated with the example nMOSFET 205, g_{m,210} is the transconductance associated with the example pMOSFET 210, C_{gs,205} is substantially the capacitance between the gate and source of the example nMOSFET 205, and also includes other stray capacitance between these two circuit nodes, R₂₃₀ is the value of the example resistor 230 and C_{c,310} is the value of the second compensation capacitor 310. Rearranging Equation 3, the value of the second compensation capacitor 310 is given by Equation 4, which is:

C_{c,310}=2(g_{m,205}g_{m,210}R₂₃₀²)C_{gs,205}. Equation 4

Assuming the example nMOSFET 205 and the example pMOSFET 210 have similar transconductances, then C_{c,310}, the value of the second compensation capacitor 310, is proportional to (gₘR)², which can be a large value. Thus, although not introducing PSRR degradation, the second compensation capacitor 310 can be a relatively large value having a correspondingly large impact on circuit area.

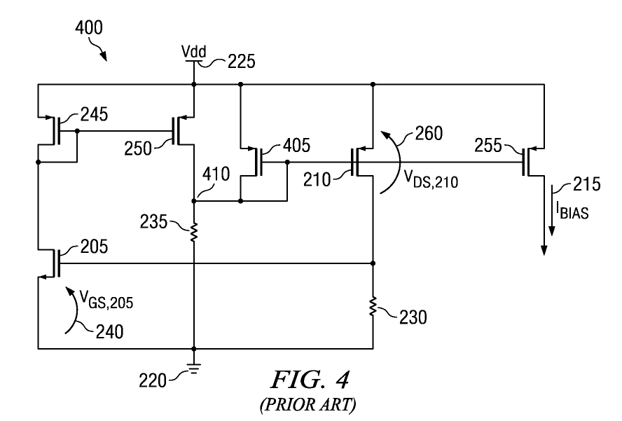

An example bias current generation circuit 400 depicting a prior art low impedance scheme not requiring a compensation capacitor to provide stability compensation for the second example prior art bias current generation circuit 200 of FIG. 2 is illustrated in FIG. 4. The example prior art bias current generation circuit 400 includes elements in common with the example prior art bias current generation circuit 200 of FIG. 2. As such, like elements in FIGS. 2 and 4 are labeled with the same reference numerals. The detailed descriptions of these like elements are provided above in connection with the discussion of FIG. 2 and, in the interest of brevity, are not repeated in the discussion of FIG. 4.

Turning to FIG. 4, the example prior art bias current generation circuit 400 includes a compensation pMOSFET 405 electrically coupled with the example pMOSFET 210 implementing the output amplifier stage of the example prior art bias current generation circuit 200. In the illustrated example, the sources of the example pMOSFETs 210 and 405 are both electrically coupled to the source Vdd voltage 225. Additionally, the gates of both example pMOSFETs 210 and 405 are electrically coupled together and to the example resistor 235, with the gate and the drain of the example pMOSFET 405 also being coupled together at a circuit node 410. Such a low impedance configuration of the example pMOSFET 405 coupled with example pMOSFET 210 reduces the impedance at the circuit node 410. Such an impedance reduction also reduces the effective gain between the gate of the example nMOSFET 205 and the gate of the example pMOSFET 210. This gain reduction and the reduction in the impedance at the circuit node 410 is sufficient to provide stability compensation in the example bias current generation circuit 400.

In the illustrated example, the low impedance circuit implemented by the example pMOSFET 405 allows compensation to be performed without the addition of a compensation capacitor, thus having less impact on circuit area. Furthermore, the low impedance circuit implemented by the example pMOSFET 405 does not significantly degrade PSRR performance of the example bias current generation circuit 400. However, the low impedance circuit implemented by the example pMOSFET 405 does introduce a systematic offset in the output bias current 215 relative to the value of the output bias current 215 generated by the example bias current generation circuit 200. In the example bias current generation circuit 200 of FIG. 2, the gate-to-source voltage 240 yielding the bias current through the example resistor 230 is set by the current at the drain of the of the example nMOSFET 205, which is substantially the same as the current through the example resistor 235 due to the current mirror circuit implemented by the example pMOSFETs 245 and 250. In the example bias current generation circuit 400 of FIG. 4, however, the current through the example resistor 235 is a combination of the current mirrored by the example pMOSFETs 245 and 250 and the current mirrored by the example pMOSFET 405 implementing the low impedance circuit from the example pMOSFET 210. As a result, the current at the drain of the example nMOSFET 205 will be only a portion of the current through the example resistor 235, resulting in a different bias of the example nMOSFET 205 and a correspondingly different gate-to-source voltage 240. This difference in the gate-to-source voltage 240 will cause the output bias current 215 generated by the example bias current generation circuit 400 to have a different value, or systematic offset, relative to the output bias current 215 generated by the example bias current generation circuit 200.

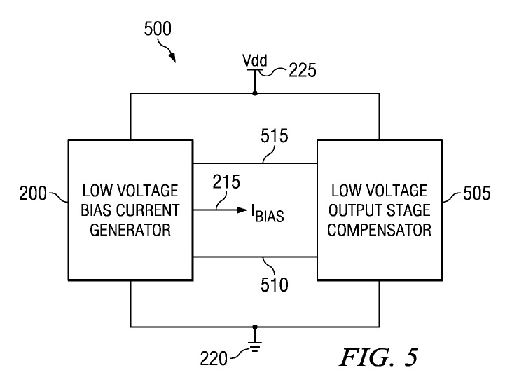

A block diagram of an example bias current generation circuit 500 supporting bias current generation according to the methods and apparatus described herein is illustrated in FIG. 5. The example bias current generation circuit 500 includes elements in common with the example prior art bias current generation circuit 200 of FIG. 2. As such, like elements in FIGS. 2 and 5 are labeled with the same reference numerals. The detailed descriptions of these like elements are provided above in connection with the discussion of FIG. 2 and, in the interest of brevity, are not repeated in the discussion of FIG. 5.

Like the example prior art bias current generation circuit 200 of FIG. 2, the example bias current generation circuit 500 of FIG. 5 utilizes a multiple amplifier stage topology to generate an output bias current while supporting low-voltage operation. However, unlike the example bias current generation circuit 300 of FIG. 3, the example bias current generation circuit 500 does not perform stability compensation through the use of compensation capacitors that can cause PSRR degradation and/or an increase in circuit size. Furthermore, although the example bias current generation circuit 500 utilizes a low impedance compensation circuit similar to the example bias current generation circuit 400 of FIG. 4 for stability compensation, the example bias current generation circuit 500 does not exhibit a systematic offset in the output bias current relative to the example prior art bias current generation circuit 200. Thus, the example bias current generation circuit 500 will provide substantially the same output bias current as the example prior art bias current generation circuit 200, thereby alleviating the need to perform additional circuit redesign to address any systematic offset of the output bias current.

Turning to FIG. 5, the example bias current generation circuit 500 includes the example prior art bias current generation circuit 200 of FIG. 2. As such, the example prior art bias current generation circuit 200 generates the output bias current 215. The example bias current generation circuit 500 also includes a low-voltage output stage compensator 505 to provide stability compensation for the example prior art bias current generation circuit 200. In the illustrated example, the low-voltage output stage compensator 505 is electrically coupled with the prior art bias current generation circuit 200 at a loading circuit node 510 and a current source node 515. As discussed in greater detail below, the example low-voltage output stage compensator 505 includes a low impedance circuit configured to be electrically coupled via the loading circuit node 510 with an output amplifier stage of the example prior art bias current generation circuit 200. Such a low impedance circuit operates to reduce the impedance of the output amplifier stage and provide stability compensation for the example prior art bias current generation circuit 200 without requiring the addition of a compensation capacitor and the associated PSRR degradation. Additionally, the example low-voltage output stage compensator 505 includes a current source electrically coupled via the current source node 515 with the example prior art bias current generation circuit 200. The current source operates to drive the low impedance circuit included in the example low-voltage output stage compensator 505 and, thus, reduce loading of the output amplifier stage to mitigate any corresponding bias introduced to the output bias current.

While an example manner of implementing the example bias current generation circuit 500 has been illustrated in FIG. 5, one or more of the circuit elements and/or devices illustrated in FIG. 5 may be combined, divided, re-arranged, omitted, eliminated and/or implemented in any other way. Further, the example prior art bias current generation circuit 200, the example low-voltage output stage compensator 505, and/or, more generally, the example bias current generation circuit 500 of FIG. 5 could be implemented by one or more integrated circuit(s), application specific integrated circuit(s) (ASIC(s)), discrete circuit elements and/or other electronic devices, etc., similar to or different from the examples illustrated in FIG. 5. Further still, the example bias current generation circuit 500 of FIG. 5 may include one or more elements and/or devices in addition to, or instead of, those illustrated in FIG. 5, and/or may include more than one of any or all of the illustrated elements and devices.

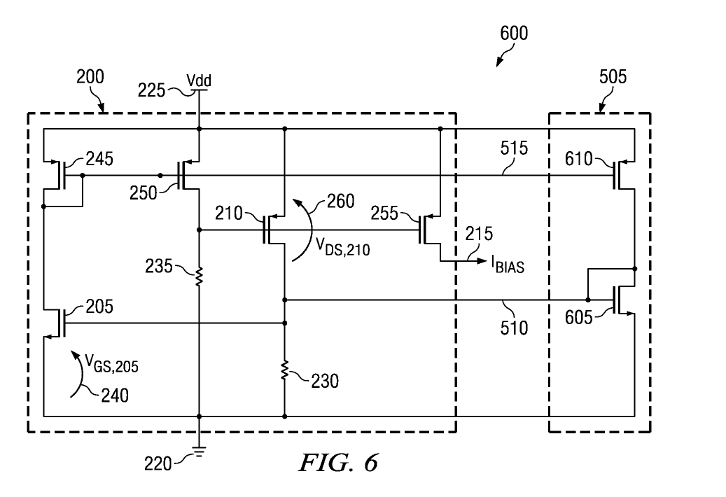

A schematic diagram of an example bias current generation circuit 600 depicting an example implementation of the bias current generation circuit 500 and, in particular, the low-voltage output stage compensator 505 of FIG. 5 is illustrated in FIG. 6. The example bias current generation circuit 600 includes elements in common with the example prior art bias current generation circuit 200 of FIG. 2 and the example bias current generation circuit 500 of FIG. 5. As such, like elements in FIGS. 2, 5 and 6 are labeled with the same reference numerals. The detailed descriptions of these like elements are provided above in connection with the discussion of FIG. 2 and 5 and, in the interest of brevity, are not repeated in the discussion of FIG. 6.

Turning to FIG. 6, the example bias current generation circuit 600 includes the example prior art bias current generation circuit 200 having a first (or initial) amplifier stage implemented by the example nMOSFET 205 and a second (or output) amplifier stage implemented by the example pMOSFET 2 10. Additionally, the example bias current generation circuit 600 includes the example low-voltage output stage compensator 505. In the illustrated example, the low impedance circuit included in the example low-voltage output stage compensator 505 is implemented by an nMOSFET 605. Furthermore, in the illustrated example, the current source included in the example low-voltage output stage compensator 505 is implemented by a pMOSFET 610.

In the illustrated example, the nMOSFET 605 is arranged in a diode configuration to implement a low impedance circuit that is electrically coupled via the loading circuit node 510 with the example pMOSFET 210 implementing the output amplifier stage of the prior art bias current generation circuit 200. To implement the low impedance circuit, the drain and the gate of the example nMOSFET 605 are electrically coupled together while the source of the nMOSFET 605 is electrically coupled with the circuit ground 220. Such a configuration causes the example nMOSFET 605 to act like a diode that will turn on and conduct current once its gate-to-source voltage exceeds its threshold voltage.

To reduce the impedance of the example pMOSFET 210 implementing the output amplifier stage and provide corresponding stability compensation for the example prior art bias current generation circuit 200, the drain and the gate of the example nMOSFET 605 are electrically coupled with the drain of the example pMOSFET 210. Such a configuration introduces a low impedance path from the drain of the example pMOSFET 210 to the circuit ground 220 via the example nMOSFET 605, thus reducing the amplifier gain associated with the example pMOSFET 210. Similar to the example compensation pMOSFET 405 included in the example bias current generation circuit 400 of FIG. 4, the example nMOSFET 605 reduces the effective gain between the gate of the example nMOSFET 205 and the gate of the example pMOSFET 210 to be approximately unity. This results in the example bias current generation circuit 600 effectively having only one gain stage that does not require an additional capacitor for stability compensation. Instead, the inherent capacitance between the gate of the example nMOSFET 210 and the source V_{dd} voltage 225 is sufficient to provide stability compensation in the example bias current generation circuit 600. Furthermore, the low impedance circuit implemented by the example nMOSFET 605 does not significantly degrade PSRR performance of the example bias current generation circuit 600. However, by itself, the low impedance circuit implemented by the example pMOSFET 605 could load the example pMOSFET 210 implementing the output amplifier stage and introduce a systematic offset in the output bias current 215 similar to the bias caused by the example compensation pMOSFET 405 included in the example bias current generation circuit 400 of FIG. 4.

To prevent the low impedance circuit implemented by the example nMOSFET 605 from loading the example pMOSFET 210 implementing the output stage amplifier, or to at least reduce such loading, and to mitigate any associated systematic offset of the output bias current 215, the example low-voltage output stage compensator 505 includes the pMOSFET 610 that implements a current source to drive the nMOSFET 605. By reducing the loading of the example pMOSFET 210 implementing the output stage amplifier, the current from the drain of the pMOSFET 210 to the example resistor 230 remains substantially unchanged after the addition of the example nMOSFET 605. As such, the output bias current 215 of the example bias current generation circuit 600 will also remain substantially unchanged relative to the example prior art bias current generation circuit 200, unlike the systematic offset exhibited by the example bias current generation circuit 400.

The example pMOSFET 610 operates as a current source by copying, or mirroring, a current provided by another circuit element that is substantially similar to a current to be carried by the example nMOSFET 605 implementing the low impedance circuit. In the example bias current generation 600, the gate of the example nMOSFET 605 is electrically coupled via the loading circuit node 510 with the gate of the example nMOSFET 205 implementing the initial stage of the example prior art bias current generation 200. Thus, the example nMOSFET 605 will carry a current substantially equal to the current provided at the drain of the example nMOSFET 205. To provide such a current to the example nMOSFET 605, the example pMOSFET 610 implementing the current source is electrically coupled with the example nMOSFET 205 via the current source node 515 and the current mirror circuit implemented by the example pMOSFETs 245 and 250. As such, the example pMOSFET 610 will mirror the current provided by the example nMOSFET 205 and provide this current to the example nMOSFET 605 implementing the low impedance circuit. In this way, the example pMOSFET 610 provides substantially all of the current to be carried by the example nMOSFET 605, thus reducing the loading experienced by the example pMOSFET 210 implementing the output amplifier stage and mitigating any associated systematic offset of the output bias current 215 generated by the example bias signal generation circuit 600.

While an example manner of implementing the example bias current generation circuit 600 has been illustrated in FIG. 6, one or more of the circuit elements and/or devices illustrated in FIG. 6 may be combined, divided, re-arranged, omitted, eliminated and/or implemented in any other way. Further, the example prior art bias current generation circuit 200, the example low-voltage output stage compensator 505, the example nMOSFETs 205 and/or 605, the example pMOSFETs 210, 245, 250, 255 and/or 610, the example resistors 230 and/or 235, and/or, more generally, the example bias current generation circuit 600 of FIG. 6 could be implemented by one or more integrated circuit(s), application specific integrated circuit(s) (ASIC(s)), discrete circuit elements and/or other electronic devices, etc., similar to or different from the examples illustrated in FIG. 6. Further still, the example bias current generation circuit 600 of FIG. 6 may include one or more elements and/or devices in addition to, or instead of, those illustrated in FIG. 6, and/or may include more than one of any or all of the illustrated elements and devices.

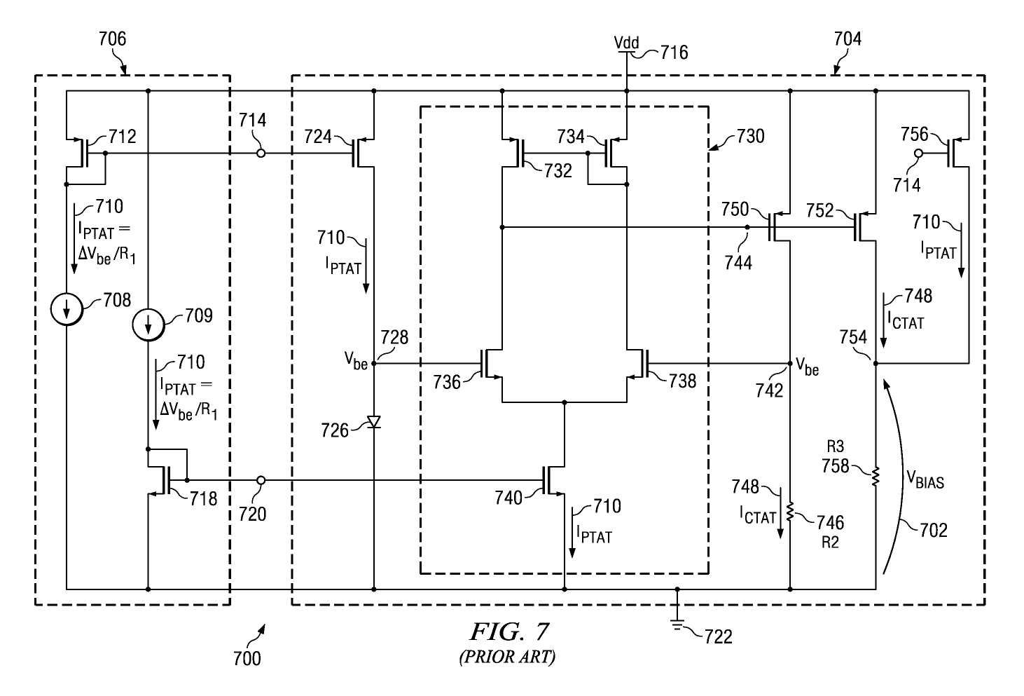

A schematic diagram of an example prior art bias voltage generation circuit 700 having multiple amplifier stages suitable for low-voltage implementation is illustrated in FIG. 7. The example prior art bias voltage generation circuit 700 is configured to implement a bandgap voltage generation circuit that generates an output bias voltage 702 that is a bandgap voltage reference. In the illustrated example, the bias voltage generation circuit 700 includes a low-voltage bandgap voltage generator 704 configured to generate the output bandgap voltage reference 702 based on a proportional-to-absolute-temperature (PTAT) current mirrored from a PTAT current source 706 electrically coupled thereto. A PTAT current is a current that has a positive temperature coefficient and, thus, increases as temperature increases (or, equivalently, decreases as temperature decreases). As described below, the example low-voltage bandgap voltage generator 704 utilizes the PTAT current provided by the PTAT current source 706 to generate a corresponding complementary-to-absolute-temperature (CTAT) current having a negative temperature coefficient that decreases as temperature increases (or, equivalently, increases as temperature decreases). The example low-voltage bandgap voltage generator 704 then combines the PTAT current with the CTAT current to produce a current that is substantially constant over temperature. The substantially constant current is then applied to a resistive element to produce the output bandgap voltage reference 702 that is substantially constant over temperature.

Turning to FIG. 7, the example PTAT current source 706 includes PTAT current generators 708 and 709 implemented using any type of circuit arrangement configured to generate a PTAT current 710 having a positive temperature coefficient. In the illustrated example, the PTAT current generator 708 is configured to generate the PTAT current 710 by applying a difference between the base-to-emitter voltages (denoted ΔV_{be}) of two transistors (not shown) to a resistive element (denoted RI and also not shown). The example PTAT current generator 708 is similarly configured to generate the PTAT current 710. Additionally, the example PTAT current source 706 also includes a pMOSFET 712 configured to mirror the PTAT current 710 via a first PTAT current node 714. To mirror the PTAT current 710 via the first PTAT current node 714, the source of the example pMOSFET 712 is electrically coupled with a source V_{dd} voltage 716, with the gate and drain of the example pMOSFET 712 being electrically coupled together and with the example PTAT current generator 708. The example PTAT current source 706 further includes an nMOSFET 718 configured to mirror the PTAT current 710 via a second PTAT current node 720. To mirror the PTAT current 710 via the second PTAT current node 720, the source of the example nMOSFET 718 is electrically coupled with a circuit ground 722, with the gate and drain of the example nMOSFET 718 being electrically coupled together and with the example PTAT current generator 708.

The example low-voltage bandgap voltage generator 704 of the example bias voltage generation circuit 700 includes a pMOSFET 724 configured to be electrically coupled with the example pMOSFET 712 of the example PTAT current generator 708 via the first PTAT current node 714. Together, the example pMOSFETs 712 and 724 implement a current mirror circuit such that the PTAT current 710 is provided at the drain of the pMOSFET 724. The example low-voltage bandgap voltage generator 704 also includes a diode 726 having an anode that is electrically coupled with the drain of the example pMOSFET 724 and a cathode that is electrically coupled with the circuit ground. The example pMOSFET 724 is configured to drive the example diode 726 to yield a bias voltage V_{be} at a first input node 728 of a differential amplifier 730.

The differential amplifier 730 provides a first, or initial, amplifier stage in the example bias voltage generation circuit 700 and may be implemented using any appropriate differential amplifier circuit topology, including that shown in FIG. 7. In the illustrated example, the differential amplifier 730 is implemented by a pair of pMOSFETs 732 and 734 electrically coupled with a pair of nMOSFETs 736 and 738 as shown. The example differential amplifier 730 also includes an nMOSFET 740 configured to be electrically coupled with the example nMOSFET 718 of the example PTAT current generator 708 via the second PTAT current node 720. Together, the example nMOSFETs 718 and 740 implement a current mirror circuit such that the PTAT current 710 is provided at the drain of the nMOSFET 740. As illustrated in FIG. 7, the example differential amplifier 730 has a first input node 728 corresponding to the base of the example nMOSFET 736, a second input node 742 corresponding to the base of the example nMOSFET 738 and an output node 744 corresponding to the drain of the example pMOSFET 732.

In the illustrated example, the voltage at the second input node 742 of the example differential amplifier 730 will be substantially equal to the bias voltage V_{be} at the first input node 728 of the example differential amplifier 730. In the example bandgap voltage generator 704, the second input node 742 of the example differential amplifier 730 is electrically coupled to a resistor 746 (labeled R₂) such that the voltage V_{be} at the second input node 742 yields a current in the resistor 746. Because of the negative temperature coefficient associated with the example diode 726, the voltage V_{be} at the second input node 742 will also have a negative temperature coefficient and decrease as temperature increases. Thus, the current induced in the resistor 746 by the voltage V_{be} at the second input node 742 is a CTAT current 748.

The example bandgap voltage generator 704 further includes a pMOSFET 750 implementing a second, or output, amplifier stage of the example bias voltage generation circuit 700. In the illustrated example, the CTAT current 748 is provided to the drain of the example pMOSFET 750. A pMOSFET 752 is electrically coupled with the pMOSFET 750 and configured to copy the CTAT current 748 for application to a constant current node 754. The example bandgap voltage generator 704 also includes a pMOSFET 756 configured to be electrically coupled with the example pMOSFET 712 of the example PTAT current generator 708 via the first PTAT current node 714. Together, the example pMOSFETs 712 and 756 implement a current mirror circuit such that the PTAT current 710 is provided at the drain of the pMOSFET 756 and applied to the constant current node 754. By combining the PTAT current 710 and the CTAT current 748 at the constant current node 754, a current that is substantially constant over temperature is used to drive a resistor 758 (labeled R3) and generate the output bandgap voltage reference 702, which is also substantially constant over temperature.

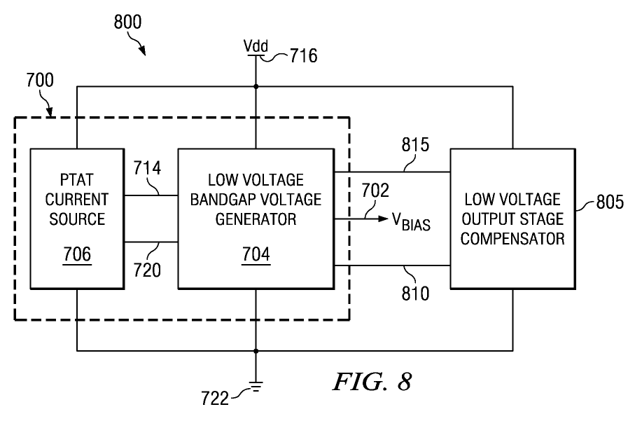

Similar to the example prior art bias current generation circuit 200 of FIG. 2 described above, the example bias voltage generation circuit 700 of FIG. 7 requires stability compensation due to its multiple gain stages and corresponding high impedance nodes. An example technique to provide stability compensation for the example bias voltage generation circuit 700 that does not require compensation capacitors and that does not cause PSRR degradation is illustrated in FIG. 8 and discussed in greater detail below.

A block diagram of an example bias voltage generation circuit 800 supporting bias voltage generation according to the methods and apparatus described herein is illustrated in FIG. 8. The example bias voltage generation circuit 800 includes elements in common with the example bias voltage generation circuit 700 of FIG. 7. As such, like elements in FIGS. 7 and 8 are labeled with the same reference numerals. The detailed descriptions of these like elements are provided above in connection with the discussion of FIG. 7 and, in the interest of brevity, are not repeated in the discussion of FIG. 8.

Turning to FIG. 8, the example bias voltage generation circuit 800 includes the example bias voltage generation circuit 700 of FIG. 7. As such, the example bias voltage generation circuit 700 includes the example low-voltage bandgap voltage generator 704 and the example PTAT current source 706 to generate the output bias voltage 702 in the form of an output bandgap voltage reference 702. The example bias voltage generation circuit 800 also includes a low-voltage output stage compensator 805 to provide stability compensation for the example bias voltage generation circuit 700. In the illustrated example, the low-voltage output stage compensator 805 is electrically coupled with the bias voltage generation circuit 700 at a loading circuit node 810 and a current source node 815. Similar to the example low-voltage output stage compensator 505 described above in connection with FIG. 5, and as discussed in greater detail below, the example low-voltage output stage compensator 805 includes a low impedance circuit configured to be electrically coupled via the loading circuit node 810 with an output amplifier stage of the example bias voltage generation circuit 700. Such a low impedance circuit operates to reduce the impedance of the output amplifier stage and provide stability compensation for the example bias voltage generation circuit 700 without requiring the addition of a compensation capacitor and the associated PSRR degradation. Additionally, the example low-voltage output stage compensator 805 includes a current source electrically coupled via the current source node 815 with the example bias voltage generation circuit 700. The current source operates to drive the low impedance circuit included in the example low-voltage output stage compensator 805 and, thus, reduce loading of the output amplifier stage to mitigate any corresponding bias introduced to the output bias voltage.

While an example manner of implementing the example bias voltage generation circuit 800 has been illustrated in FIG. 8, one or more of the circuit elements and/or devices illustrated in FIG. 8 may be combined, divided, re-arranged, omitted, eliminated and/or implemented in any other way. Further, the example bias voltage generation circuit 700, the example low-voltage bandgap voltage generator 704, the example PTAT current source 706, the example low-voltage output stage compensator 805, and/or, more generally, the example bias voltage generation circuit 800 of FIG. 8 could be implemented by one or more integrated circuit(s), application specific integrated circuit(s) (ASIC(s)), discrete circuit elements and/or other electronic devices, etc., similar to or different from the examples illustrated in FIG. 8. Further still, the example bias voltage generation circuit 800 of FIG. 8 may include one or more elements and/or devices in addition to, or instead of, those illustrated in FIG. 8, and/or may include more than one of any or all of the illustrated elements and devices.

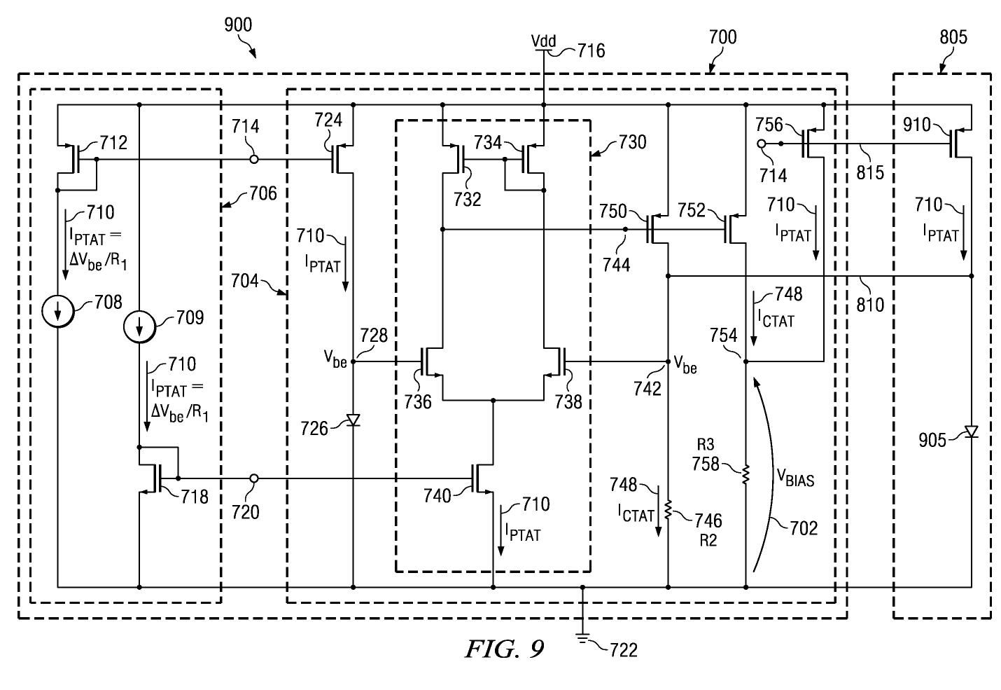

A schematic diagram of an example bias voltage generation circuit 900 depicting an example implementation of the bias voltage generation circuit 800 and, in particular, the low-voltage output stage compensator 805 of FIG. 8 is illustrated in FIG. 9. The bias voltage generation circuit 900 includes elements in common with the example bias voltage generation circuit 700 of FIG. 7 and the example bias voltage generation circuit 800 of FIG. 8. As such, like elements in FIGS. 7, 8 and 9 are labeled with the same reference numerals. The detailed descriptions of these like elements are provided above in connection with the discussion of FIG. 7 and 8 and, in the interest of brevity, are not repeated in the discussion of FIG. 9.

Turning to FIG. 9, the example bias voltage generation circuit 900 includes the example bias voltage generation circuit 700 having a first (or initial) amplifier stage implemented by the example differential amplifier 730 and a second (or output) amplifier stage implemented by the example pMOSFET 750. Additionally, the example bias voltage generation circuit 900 includes the example low-voltage output stage compensator 805. In the illustrated example, the low impedance circuit included in the example low-voltage output stage compensator 805 is implemented by a diode 905. Furthermore, in the illustrated example, the current source included in the example low-voltage output stage compensator 505 is implemented by a pMOSFET 910.

In the illustrated example, the diode 905 implements a low impedance circuit that is electrically coupled via the loading circuit node 810 with the example pMOSFET 750 implementing the output amplifier stage of the bias voltage generation circuit 700. To reduce the impedance of the example pMOSFET 750 implementing the output amplifier stage and provide corresponding stability compensation for the example bias voltage generation circuit 700, the anode of the example diode 905 is electrically coupled with the drain of the example pMOSFET 750. Such a configuration introduces a low impedance path from the drain of the example pMOSFET 750 to the circuit ground 722, thus reducing the amplifier gain associated with the example pMOSFET 750. The example diode 905, therefore, reduces the effective gain associated with the example pMOSFET 750 to be approximately unity. This results in the example bias voltage generation circuit 700 effectively having only one gain stage that does not require an additional capacitor for stability compensation. Furthermore, the low impedance circuit implemented by the example diode 905 does not significantly degrade PSRR performance of the example bias voltage generation circuit 700. However, by itself, the low impedance circuit implemented by the example diode 905 could load the example pMOSFET 750 implementing the output amplifier stage of the example bias voltage generation circuit 700 and introduce a systematic offset in the output bias voltage 702.

To prevent the low impedance circuit implemented by the example diode 905 from loading the example pMOSFET 750 implementing the output stage amplifier, or to at least reduce such loading, and to mitigate any associated systematic offset of the output bias voltage 702, the example low-voltage output stage compensator 805 includes the pMOSFET 910 that implements a current source to drive the diode 905. By reducing the loading of the example pMOSFET 750 implementing the output stage amplifier, the current provided by the drain of the pMOSFET 720 to the example resistor 748 remains substantially unchanged after the addition of the example diode 905. As such, the output bias voltage 702 of the example bias voltage generation circuit 900 will also remain substantially unchanged relative to the example bias voltage generation circuit 700.

The example pMOSFET 910 operates as a current source by copying or mirroring a current provided by another circuit element that substantially similar to a current to be carried by the example diode 905 implementing the low impedance circuit. In the example bias voltage generation circuit 900, the anode of the diode 905 is electrically coupled via the loading circuit node 810 with the second input node 742 of the example differential amplifier 730 implementing the initial stage of the example bias voltage generation circuit 700. Because the bias voltage V_{be} at the second input node 742 is substantially equal to the bias voltage V_{be} at the first input node 728 to which the anode of the example diode 726 is coupled, the example diode 905 will carry a current substantially equal to the current carried by the example diode 726 and provided by the example pMOSFET 724. To provide such a current to the diode 905, the example pMOSFET 910 implementing the current source is electrically coupled with the example pMOSFET 724 via the current source node 815 and the first PTAT current node 714. As such, the example pMOSFET 910 will mirror the current provided by the example pMOSFET 724 and provide this current to the example diode 905 implementing the low impedance circuit. In this way, the example pMOSFET 910 provides substantially all of the current to be carried by the example diode 905, thus reducing the loading experienced by the example pMOSFET 750 implementing the output amplifier stage and mitigating any associated systematic offset of the output bias voltage 702 generated by the example bias voltage generation circuit 900.

While an example manner of implementing the example bias voltage generation circuit 900 has been illustrated in FIG. 9, one or more of the circuit elements and/or devices illustrated in FIG. 9 may be combined, divided, re-arranged, omitted, eliminated and/or implemented in any other way. Further, the example bias voltage generation circuit 700, the example low-voltage bandgap voltage generator 704, the example PTAT current source 706, the example PTAT current generators 708 and/or 709, the example differential amplifier 730, the example low-voltage output stage compensator 805, the example nMOSFETs 718, 736, 738 and/or 740, the example pMOSFETs 712, 732, 734, 750, 752, 756 and/or 910, the example resistors 746 and/or 758, the example diodes 726 and/or 905, and/or, more generally, the example bias voltage generation circuit 900 of FIG. 9 could be implemented by one or more integrated circuit(s), application specific integrated circuit(s) (ASIC(s)), discrete circuit elements and/or other electronic devices, etc., similar to or different from the examples illustrated in FIG. 9. Further still, the example bias voltage generation circuit 900 of FIG. 9 may include one or more elements and/or devices in addition to, or instead of, those illustrated in FIG. 9, and/or may include more than one of any or all of the illustrated elements and devices.

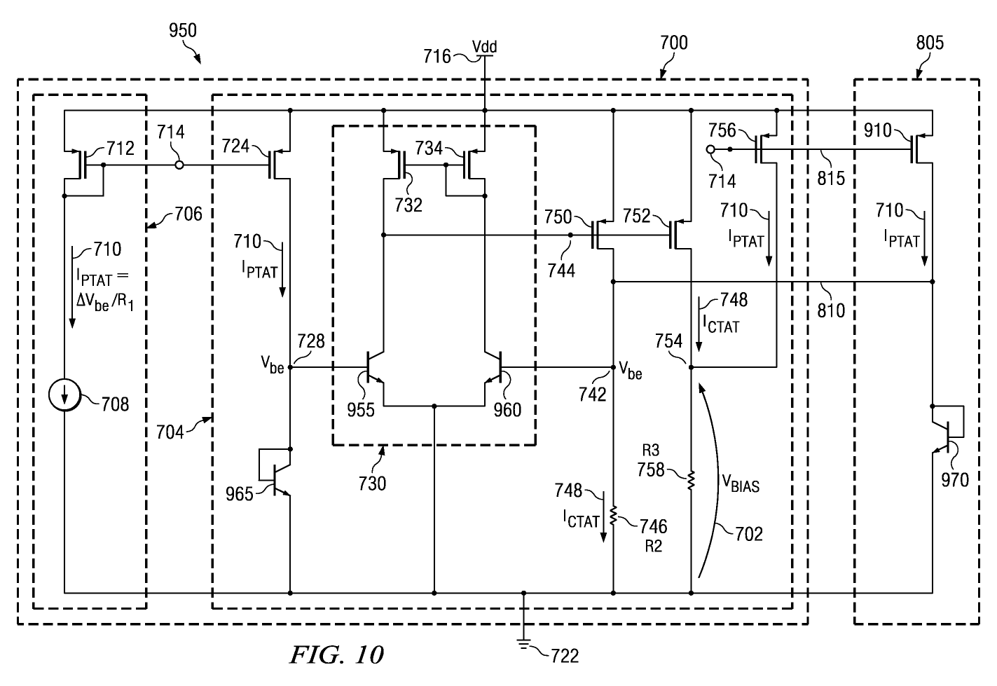

A schematic diagram of a second example bias voltage generation circuit 950 depicting an example implementation of the bias voltage generation circuit 800 is illustrated in FIG. 10. The bias voltage generation circuit 950 includes elements in common with the example bias voltage generation circuit 700 of FIG. 7, the example bias voltage generation circuit 800 of FIG. 8 and the example bias voltage generation circuit 900 of FIG. 9. As such, like elements in FIGS. 7-9 and 10 are labeled with the same reference numerals. The detailed descriptions of these like elements are provided above in connection with the discussion of FIG. 7-9 and, in the interest of brevity, are not repeated in the discussion of FIG. 10.

Turning to FIG. 10, the example bias voltage generation circuit 950 provides an alternative implementation of the example differential amplifier 730. In the illustrated example of FIG. 10, the example nMOSFETs 736, 738 and nMOSFET 740 used to implement the differential amplifier 730 in the examples circuits of FIGS. 7 and 9 are replaced with bipolar junction transistors (BJTs) 955 and 960 as shown in the example bias voltage generation circuit 950. Such an example implementation of the example differential amplifier 730 eliminates the need for the example PTAT current generators 709 and the example nMOSFET 718 included in the example circuits of FIGS. 7 and 9. Additionally, in the example bias voltage generation circuit 950, the diodes 726 and 905 included in the example circuit of FIG. 9 are replaced with respective BJTs 965 and 970, each arranged in a diode configuration. As shown in FIG. 10, the diode-configured BJT 965 yields the bias voltage V_{be} at the first input node 728 of the differential amplifier 730, which can be applied directly to the BJTs 955 and 960 to yield the bias voltage V_{be} at the second input node 742 of the differential amplifier 730. Operation of the remainder of the example bias voltage generation circuit 950 is similar to that of the example bias voltage generation circuit 900 described above in connection with FIG. 9.

While an example manner of implementing the example bias voltage generation circuit 950 has been illustrated in FIG. 10, one or more of the circuit elements and/or devices illustrated in FIG. 10 may be combined, divided, re-arranged, omitted, eliminated and/or implemented in any other way. Further, the example bias voltage generation circuit 700, the example low-voltage bandgap voltage generator 704, the example PTAT current source 706, the example PTAT current generator 708, the example differential amplifier 730, the example low-voltage output stage compensator 805, the example pMOSFETs 712, 732, 734, 750, 752, 756 and/or 910, the example resistors 746 and/or 758, the example BJTs 955, 960, 965 and/or 970, and/or, more generally, the example bias voltage generation circuit 950 of FIG. 10 could be implemented by one or more integrated circuit(s), application specific integrated circuit(s) (ASIC(s)), discrete circuit elements and/or other electronic devices, etc., similar to or different from the examples illustrated in FIG. 10. Further still, the example bias voltage generation circuit 950 of FIG. 10 may include one or more elements and/or devices in addition to, or instead of, those illustrated in FIG. 10, and/or may include more than one of any or all of the illustrated elements and devices.

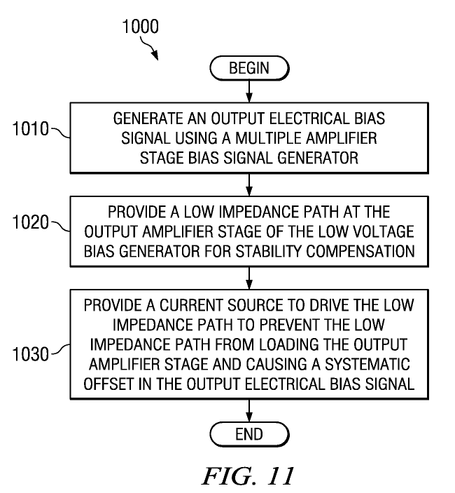

A flowchart representative of an example process that may be implemented by all, or at least portions of, the example bias current generation circuit 500, the example bias current generation circuit 600, the example low-voltage output stage compensator 505, the example bias voltage generation circuit 800, the example bias voltage generation circuit 900, the example bias voltage generation circuit 950, and/or the example low-voltage output stage compensator 805 is shown in FIG. 11. Additionally or alternatively, any, all or portions thereof of the example bias current generation circuit 500, the example bias current generation circuit 600, the example low-voltage output stage compensator 505, the example bias voltage generation circuit 800, the example bias voltage generation circuit 900, the example low-voltage output stage compensator 805, and/or the example process represented by the flowchart of FIG. 11 could be implemented by any combination of software, firmware, hardware devices and/or combinational logic, other circuitry, etc., configured to implement functionality similar to the hardware circuitry shown in FIGS. 5-6 and 8-9. Also, some or all of the process represented by the flowchart of FIG. 11 may be implemented manually. Further, although the example process is described with reference to the flowchart illustrated in FIG. 11, many other techniques for implementing the example methods and apparatus described herein may alternatively be used. For example, with reference to the flowchart illustrated in FIG. 11, the order of execution of the blocks may be changed, and/or some of the blocks described may be changed, eliminated, combined and/or subdivided into multiple blocks.

An example stability compensation process 1000 that may be implemented by the example bias current generation circuit 500 of FIG. 5, the example bias current generation circuit 600 of FIG. 6, the example bias voltage generation circuit 800 of FIG. 8, the example bias voltage generation circuit 900 of FIG. 9 and/or the example bias voltage generation circuit 950 of FIG. 10 is illustrated in FIG. 11. The example stability compensation process 1000 operates to perform stability compensation for low-voltage bias signal generation circuits implemented using multiple amplifier stages, such as the circuits illustrated in FIGS. 5, 6, 8 and/or 9, but without requiring compensation capacitors, without causing PSRR degradation and without introducing a systematic offset to the generated bias signal. In the interest of brevity, and unless otherwise noted, operation of the example stability compensation process 1000 is described with reference to a generic low-voltage, multiple amplifier stage bias signal generation circuit, which could be the example bias current generation circuit 500, the example bias current generation circuit 600, the example bias voltage generation circuit 800, the example bias voltage generation circuit 900 and/or the example bias voltage generation circuit 950.

Turning to FIG. 11, the example stability compensation process 1000 begins at block 1010 at which the low-voltage bias signal generation circuit generates an output electrical bias signal using a multiple amplifier stage bias signal generator. For example, at block 1010 the example bias current generation circuit 500 and/or the example bias current generation circuit 600 may generate the output bias current 215 using a multiple amplifier stage configuration implemented, for example, by the example nMOSFET 205 and the example pMOSFET 2 10. As another example, at block 1010 the example bias voltage generation circuit 800 and/or the example bias voltage generation circuit 900 may generate the output bias voltage 702 using a multiple amplifier stage configuration implemented, for example, by the example differential amplifier 730 and the example pMOSFET 750.

Next, control proceeds to block 1020 at which the low-voltage bias signal generation circuit provides a low impedance path at the output amplifier stage of the low-voltage bias signal generation circuit for stability compensation. For example, at block 1020 the example bias current generation circuit 500 and/or the example bias current generation circuit 600 may provide a low impedance path at the output amplifier stage implemented by the example pMOSFET 210, with the low impedance path being implemented by a diode or the example nMOSFET 605 arranged in a diode configuration. As another example, at block 1020 the example bias voltage generation circuit 800 and/or the example bias voltage generation circuit 900 may provide a low impedance path at the output amplifier stage implemented by the example pMOSFET 750, with the low impedance path being implemented by the example diode 905. As discussed above, such a low impedance path results in the low-voltage bias signal generation circuit effectively having only one gain stage that does not require an additional capacitor for stability compensation. Furthermore, the low impedance circuit implemented does not significantly degrade PSRR performance of the low-voltage bias signal generation circuit.

Control next proceeds to block 1030 at which the low-voltage bias signal generation circuit provides a current source to drive the low impedance path to prevent the low impedance path from loading the output amplifier stage and causing a systematic offset of the output electrical bias signal. For example, at block 1030 the example bias current generation circuit 500 and/or the example bias current generation circuit 600 may provide a current source to drive the example nMOSFET 605 implementing the low impedance path, with the current source implemented by the example pMOSFET 610 configured to mirror the current provided by the example nMOSFET 205. As another example, at block 1030 the example bias voltage generation circuit 800 and/or the example bias voltage generation circuit 900 may provide a current source to drive the example diode 905 implementing the low impedance path, with the current source implemented by the example pMOSFET 910 configured to mirror the PTAT current provided by the example pMOSFET 724. In this way, the current source drives the low impedance path with a current that the low impedance path expects to carry, thereby allowing the output amplifier stage of the low-voltage bias signal generation circuit to generate an output electrical bias signal that exhibits little to no systematic offset.

After processing at block 1030 completes, execution of the example stability compensation process 1000 ends.

As an alternative to implementing the methods and/or apparatus described herein using hardware circuitry and/or devices such as those shown in FIGS. 5-6 and 8-9, the methods and or apparatus described herein may be embedded in a structure such as a processor and/or an ASIC (application specific integrated circuit).

Finally, although certain example apparatus, methods, and articles of manufacture are described herein, other implementations are possible. The scope of coverage of this patent is not limited to the specific examples described herein. On the contrary, this patent covers all apparatus, methods, and articles of manufacture falling within the scope of the invention.

What is claimed is:

1. A bias signal generation circuit comprising:
a first amplifier stage;
an output amplifier stage electrically coupled with the first amplifier stage, the first amplifier stage and the output amplifier stage configured to generate an output bias signal, the output amplifier stage configured to provide the output bias signal;
a low impedance circuit electrically coupled with the output amplifier stage, the low impedance circuit configured to reduce an impedance of the output amplifier stage; and
a current source electrically coupled with the low impedance circuit, the current source configured to drive the low impedance circuit to reduce loading of the output amplifier stage by the low impedance circuit.

2. A bias signal generation circuit as defined in claim 1, wherein the low impedance circuit comprises a diode circuit electrically coupled between the output amplifier stage and a circuit ground.

3. A bias signal generation circuit as defined in claim 2, wherein the output amplifier stage comprises a p-type metal-oxide-semiconductor field-effect transistor (MOSFET) and the diode circuit is electrically coupled between a drain of the p-type MOSFET and the circuit ground.

4. A bias signal generation circuit as defined in claim 3, wherein the diode circuit is implemented by an n-type MOSFET having a drain and a gate that are electrically coupled with the drain of the p-type MOSFET, the n-type MOSFET further having a source that is electrically coupled with the circuit ground.

5. A bias signal generation circuit as defined in claim 1, wherein the current source comprises a current mirror circuit electrically coupled with the low impedance circuit and a second circuit element, the second circuit element configured to provide a first current substantially equal to a second current to be carried by the low impedance circuit.

6. A bias signal generation circuit as defined in claim 5, wherein the second circuit element comprises a first n-type MOSFET configured to provide the first current and the low impedance circuit comprises a second n-type MOSFET, wherein a source of the first n-type MOSFET is electrically coupled with a source of the second n-type MOSFET via a circuit ground and a drain of the first n-type MOSFET is electrically coupled with a drain of the second n-type MOSFET via the current mirror circuit, and wherein a gate of the first n-type MOSFET is electrically coupled with a gate and a drain of the second n-type MOSFET resulting in the second n-type MOSFET carrying the second current that is substantially equal to the first current provided by the first n-type MOSFET.

7. A bias signal generation circuit as defined in claim 6, wherein the output bias signal comprises an output bias current and the output amplifier stage comprises a first p-type MOSFET, the gate of the first n-type MOSFET is electrically coupled with a drain of the first p-type MOSFET and a resistor, the first n-type MOSFET is biased to generate a first current through the resistor and a second current at the drain of the first p-type MOSFET both substantially equal to the output bias current, and wherein the gate and the drain of the second n-type MOSFET included in the low impedance circuit are electrically coupled with the drain of the first p-type MOSFET to reduce the impedance associated with the first p-type MOSFET.

8. A bias signal generation circuit as defined in claim 7, wherein the output amplifier stage further comprises a second p-type MOSFET electrically coupled with the first p-type MOSFET, the second p-type MOSFET configured to substantially copy the second current at the drain of the first p-type MOSFET and to provide the output bias current at a drain of the second p-type MOSFET.

9. A bias signal generation circuit as defined in claim 5, wherein the second circuit element comprises a first p-type MOSFET configured to provide a proportional-to-absolute-temperature (PTAT) current to a first diode circuit electrically coupled thereto, the low impedance circuit comprises a second diode circuit, a cathode of the first diode circuit is electrically coupled with a cathode of the second diode circuit via a circuit ground, and wherein an anode of the first diode circuit is electrically coupled with an anode of the second diode circuit via the current mirror circuit resulting in the second diode circuit carrying the second current that is substantially equal to the first current provided by the first p-type MOSFET.

10. A bias signal generation circuit as defined in claim 9, wherein the output bias signal comprises an output bandgap voltage and the output amplifier stage comprises a second p-type MOSFET, a source of the first p-type MOSFET is electrically coupled with a source of the second p-type MOSFET, a drain of the first p-type MOSFET is electrically coupled with a drain of the second p-type MOSFET via a differential amplifier circuit configured to generate a complementary-to-absolute-temperature (CTAT) current at the drain of the second p-type MOSFET, the CTAT current contributing to generation of the output bandgap voltage, and wherein the anode of the second diode circuit included in the low impedance circuit is electrically coupled with the drain of the second p-type MOSFET to reduce the impedance associated with the second p-type MOSFET.

11. A bias signal generation circuit as defined in claim 10, wherein the output amplifier stage further comprises a third p-type MOSFET electrically coupled with the second p-type MOSFET and the first p-type MOSFET, the third p-type MOSFET configured to combine a substantial copy of the CTAT current provided by the second p-type MOSFET and a substantial copy of the PTAT current provided by the first p-type MOSFET to drive a resistor coupled thereto to produce the output bandgap voltage.

12. A bias signal generation circuit as defined in claim 9, wherein at least one of the first diode circuit or the second diode circuit is implemented by at least one of a second p-type MOSFET or a first n-type MOSFET.

13. A low-voltage bias current generation circuit comprising:
a first n-type metal-oxide-semiconductor field-effect transistor (MOSFET) biased to generate a first current at the drain of the first n-type MOSFET and a second current through a resistor electrically coupled with a gate of the first n-type MOSFET;
a first p-type MOSFET having a drain electrically coupled with the resistor to provide a third current at the drain of the first p-type MOSFET;
a second n-type MOSFET having a drain and a gate that are electrically coupled with the drain of the first p-type MOSFET, the second n-type MOSFET further having a source that is electrically coupled with the circuit ground, the second n-type MOSFET configured to reduce an impedance of the first p-type MOSFET; and
a second p-type MOSFET electrically coupled with the first n-type MOSFET via a current mirror circuit, the second p-type MOSFET also having a drain electrically coupled with the drain and the gate of the second n-type MOSFET, the second p-type MOSFET configured to provide a fourth current to the second n-type MOSFET substantially equal to the first current at the drain of the first n-type MOSFET and to cause the second current through the resistor to be substantially equal to the third current at the drain of the first p-type MOSFET, the third current at the drain of the first p-type MOSFET corresponding to a bias current output by the low-voltage bias current generation circuit.

14. A low-voltage bandgap voltage generation circuit comprising:
a first p-type MOSFET configured to provide a proportional-to-absolute-temperature (PTAT) current to a first diode circuit electrically coupled thereto;
a second p-type MOSFET having a source electrically coupled with a source of the first p-type MOSFET and a drain electrically coupled with a drain of the second p-type MOSFET via a differential amplifier circuit configured to generate a complementary-to-absolute-temperature (CTAT) current at the drain of the second p-type MOSFET;
a third p-type MOSFET electrically coupled with the second p-type MOSFET and the first p-type MOSFET, the third p-type MOSFET configured to combine a first current substantially equal to the CTAT current provided by the second p-type MOSFET and a second current substantially equal to the PTAT current provided by the first p-type MOSFET to drive a resistor coupled thereto to produce an output bandgap voltage;
a second diode circuit having an anode electrically coupled with the drain of the second p-type MOSFET and a cathode electrically coupled with a circuit ground, the second diode circuit configured to reduce an impedance of the second p-type MOSFET; and
a fourth p-type MOSFET electrically coupled with the second diode circuit and configured to provide a third current substantially equal to the PTAT current to the second diode circuit and to reduce a fourth current drawn by the second diode circuit from the drain of the second p-type MOSFET to a substantially zero value.

15. A method to generate an electrical bias signal, the method comprising:
generating the electrical bias signal using a first amplifier stage and a second amplifier stage, the second amplifier stage providing the electrical bias signal;
reducing an impedance of the second amplifier stage using a low impedance circuit electrically coupled with the second amplifier stage; and
reducing an offset in the electrical bias signal caused by the low impedance circuit using a current source electrically coupled with the low impedance circuit, the current source configured to drive the low impedance circuit to reduce loading of the second amplifier stage by the low impedance circuit.

16. A method as defined in claim 15, wherein the low impedance circuit comprises a diode circuit electrically coupled between the second amplifier stage and a circuit ground and the current source comprises a current mirror circuit electrically coupled with the diode circuit and a second circuit element, the second circuit element configured to provide a first current substantially equal to a second current to be carried by the diode circuit.

17. A method as defined in claim 16, wherein the second amplifier stage comprises a first p-type metal-oxide-semiconductor field-effect transistor (MOSFET) and the diode circuit is implemented by a first n-type MOSFET having a drain and a gate that are electrically coupled with the drain of the first p-type MOSFET, the first n-type MOSFET further having a source that is electrically coupled with the circuit ground.

18. A method as defined in claim 17, wherein the electrical bias signal comprises a bias current, the second circuit element comprises a second n-type MOSFET configured to provide the first current, the source of the second n-type MOSFET is electrically coupled with a source of the first n-type MOSFET implementing the low impedance circuit via the circuit ground, a drain of the first n-type MOSFET is electrically coupled with a drain of the second n-type MOSFET via the current mirror circuit, the gate and the drain of the first n-type MOSFET are electrically coupled with a gate of the second n-type MOSFET resulting in the first n-type MOSFET carrying the second current that is substantially equal to the first current provided by the second n-type MOSFET, the gate of the second n-type MOSFET is electrically coupled with a drain of the first p-type MOSFET and a resistor, the second n-type MOSFET is biased to generate a first current through the resistor and a second current at the drain of the first p-type MOSFET both substantially equal to the bias current, and wherein the gate and the drain of the first n-type MOSFET implementing the low impedance circuit are electrically coupled with the drain of the first p-type MOSFET to reduce the impedance associated with the first p-type MOSFET.

19. A method as defined in claim 16, wherein the diode circuit is a first diode circuit, the electrical bias signal comprises a bandgap voltage, the second circuit element comprises a first p-type MOSFET configured to provide a proportional-to-absolute-temperature (PTAT) current to a second diode circuit electrically coupled thereto, a cathode of the first diode circuit implementing the low impedance circuit is electrically coupled with a cathode of the second diode circuit via a circuit ground, an anode of the first diode circuit is electrically coupled with an anode of the second diode circuit via the current mirror circuit resulting in the first diode circuit carrying the second current that is substantially equal to the first current provided by the first p-type MOSFET to the second diode circuit, the second amplifier stage comprises a second p-type MOSFET electrically coupled with a third p-type MOSFET, a source of the first p-type MOSFET is electrically coupled with a source of the second p-type MOSFET, a drain of the first p-type MOSFET is electrically coupled with a drain of the second p-type MOSFET via a differential amplifier circuit configured to generate a complementary-to-absolute-temperature (CTAT) current at the drain of the second p-type MOSFET, the anode of the second diode circuit included in the low impedance circuit is electrically coupled with the drain of the second p-type MOSFET to reduce the impedance associated with the second p-type MOSFET, and wherein the third p-type MOSFET is configured to combine a substantial copy of the CTAT current provided by the second p-type MOSFET and a substantial copy of the PTAT current provided by the first p-type MOSFET to drive a resistor coupled thereto to produce the bandgap voltage.

20. A method as defined in claim 19, wherein at least one of the first diode circuit or the second diode circuit is implemented by a bipolar junction transistor.
